(19) United States
(12) Patent Application Publication
(10) Pub. No.: US 2008/0176089 A1
(43) Pub. Date: Jul. 24, 2008

(54) WALLPAPER TYPE DECORATION PANEL HAVING DECORATION PATTERN OF UNEVENNESS FORM

(76) Inventor: Gi-Bong LEE, Incheon (KR)

Correspondence Address: LADAS & PARRY LLP, 224 SOUTH MICHIGAN AVENUE, SUITE 1600, CHICAGO, IL, 60604, US

(21) Appl. No.: 12/015,572

(22) Filed: Jan. 17, 2008

(30) Foreign Application Priority Data
Jan. 24, 2007 (KR) 10-2007-0007276

(51) Int. Cl. B32B 29/00; B32B 15/10

(52) U.S. Cl. 428/464; 428/537.5

(57) ABSTRACT

Provided is a wallpaper type decoration panel having a decoration pattern of an unevenness form, which is formed by compressing and molding an intermediate member and a finish member on a board member under a high temperature and high pressure. Accordingly, the pattern of the intermediate member is protruded as the decoration pattern, to thus fulfill various consumer's aesthetic desires and to maximize reliability of use. An embroidered fabric or a flocking processed fabric is used as the intermediate member, or a flocking is directly attached on the upper surface of the board member or the inner side surface of the finish member. Accordingly, various decoration patterns are effectively produced, to thereby improve productivity and provide an effect of reducing a manufacturing cost.

### CROSS-REFERENCE TO RELATED APPLICATION

This application claims the benefit of Korean Patent Application No. 10-2007-0007276, filed on Jan. 24, 2007, and then registered as Korean Patent Registration No. 10-0768253 on Oct. 11, 2007, in the Korean Intellectual Property Office, the disclosure of which is incorporated herein by reference.

### BACKGROUND OF THE INVENTION

1. Field of the Invention

The present invention relates to a wallpaper type decoration panel having a decoration pattern of an unevenness form, in which when a variety of uneven decoration patterns are formed on the outer surface of the decoration panel, an embroidered fabric or a flocking processed fabric is used to form the decoration pattern, to thereby improve productivity and diversity and maximize reliability of use, and provide an effect of reducing a manufacturing cost.

2. Description of the Related Art

In general, decoration panels are attached on indoor or outdoor building materials, various kinds of furniture and accessories in various forms, to thus improve aesthetics remarkably.

The conventional decoration panels are made by coating and bonding PVC (polyvinylchloride) sheets forming various colors or patterns on the surfaces of board members such as medium-density fiberboards (MDFs), particle boards (PBs), plywoods or gypsum boards, or by attaching a printed paper sheet thereon.

However, the conventional decoration panels have been offered only at a state where the surfaces of the boards are flat, respectively.

That is, a sense of beauty is given by the colors or patterns which are two-dimensionally expressed on the surfaces of the decoration panels. Thus, there is a limit to satisfy consumer's various aesthetic desires.

In order to offer a sense of beauty differing from the conventional technology, a fiber layer is formed on the surface of a board member, and various designs are printed on the fiber layer, to thereby provide a decoration panel. However, such a decoration panel is made of the same simple plane form as that of the conventional decoration panel, except unique texture of the fiber layer, to thereby fail to fulfill consumer's various aesthetic desires.

Meanwhile, a dam bar board was disclosed as another conventional technology differing from the above-described conventional technologies. Here, grooves are fabricated to form predetermined decorative patterns on the surface of a board member by a NC (numerical control) machining process, and then the surface of the board member is painted or a sheet is adhered on the surface of the board member, to thereby express a three-dimensional decorative pattern on the board member.

However, since the dam bar board employs a machining process on the surface of the board member, the phenotypes of the decoration patterns are not versatile. Accordingly, the dam bar board also fails to effectively fulfill consumer's various aesthetic desires.

In addition, since the surface of the board member is processed by the NC machine, productivity does not only decline but also price is high to thereby make it difficult to use the dam bar board.

### SUMMARY OF THE INVENTION

To overcome inconveniences of the conventional art, it is an object of the present invention to provide a wallpaper type decoration panel having a decoration pattern of an unevenness form, in which a variety of uneven decoration patterns are formed on the outer surface of the decoration panel, unlike a conventional mechanical method which forms a decoration pattern on a board member as a limited form, to thereby fulfill consumer's various aesthetic desires, and maximize reliability of use.

It is another object of the present invention to provide a wallpaper type decoration panel having a decoration pattern of an unevenness form, in which an embroidered fabric or a flocking processed fabric is used to form the decoration pattern, to thereby improve productivity and diversity and provide an effect of reducing a manufacturing cost.

To accomplish the above object of the present invention, there is provided a wallpaper type decoration panel having a decoration pattern of an unevenness form, the wallpaper type decoration panel comprising: a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate; an intermediate member which forms various decoration patterns of a protruded form and which is adhered to the upper surface of the board member; and a finish member which is compression-molded on the outer surface of the intermediate member under a high temperature and high pressure, so that the protruded pattern of the intermediate member is protruded as the decoration pattern on the outer surface of the finish member.

Preferably but not necessarily, the wallpaper type decoration panel further comprises: a painted layer which is painted between the intermediate member and the finish member using one of charcoal, lacquer, and yellow soil.

Preferably but not necessarily, an embroidered fabric on which various patterns are protrudingly embroidered is used as the intermediate member, or a flocking processed fabric on which very small minute particles are sprayed to thus attach various patterns in a protruding form, is used as the intermediate member.

Preferably but not necessarily, instead of using the intermediate member, a flocking process can be used in which very small minute particles are sprayed onto the upper surface of the board member, or the inner surface of the finish member, in order to attach various patterns in a protruding form.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a front view showing a decoration panel according to an embodiment of the present invention;

FIG. 2 is a cross-sectional view showing a decoration panel according to an embodiment of the present invention;

FIG. 3 is a cross-sectional view showing a decoration panel according to another embodiment of the present invention;

FIG. 4 is a cross-sectional view showing a decoration panel according to still another embodiment of the present invention;

FIG. 5 is a cross-sectional view showing a decoration panel according to yet another embodiment of the present invention;

FIG. 6 is a cross-sectional view showing a decoration panel according to the present invention is compression-molded by a roller;

FIG. 7 is a cross-sectional view showing a decoration panel according to the present invention is compression-molded by a hot press; and

FIG. 8 is a schematic diagram showing a decoration panel according to still yet another embodiment of the present invention.

### DETAILED DESCRIPTION OF THE INVENTION

Hereinbelow, a wallpaper type decoration panel having a decoration pattern of an unevenness form according to the present invention will be described with reference to the accompanying drawings. Like reference numerals are assigned for like elements in the drawings.

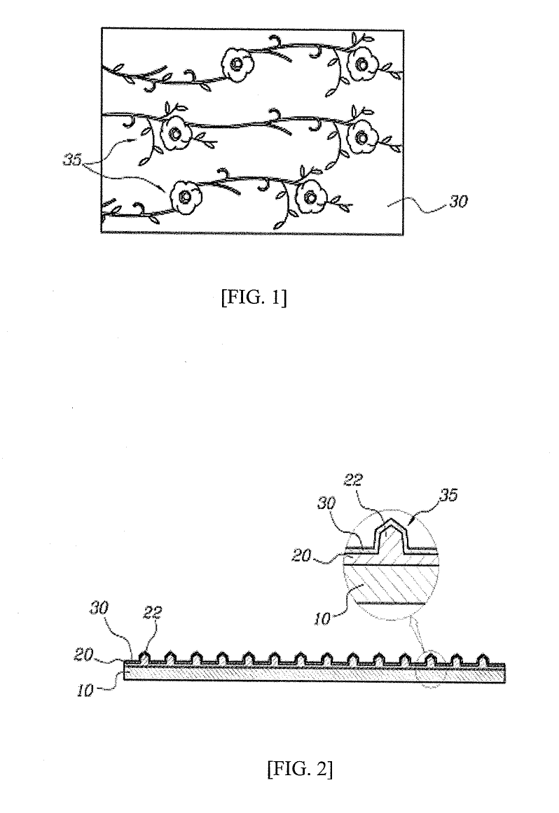

As shown in FIGS. 1 and 2, a wallpaper type decoration panel having a decoration pattern of an unevenness form according to the present invention includes: a board member 10 such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate; an intermediate member 20 which forms various decoration patterns 22 of a protruded form and which is adhered to the upper surface of the board member 10; and a finish member 30 which is compression-molded on the outer surface of the intermediate member 20 under a high temperature and high pressure, so that the protruded pattern 22 of the intermediate member 20 is protruded as the decoration pattern 35 on the outer surface of the finish member 30.

Here, an embroidered fabric on which various patterns are protrudingly embroidered is used as the intermediate member 20, so that the embroidered pattern of the fabric forms the decoration pattern 35.

In addition, a flocking processed fabric on which very small minute particles are sprayed to thus attach various patterns in a protruding form, is used as the intermediate member 20, so that the flocking pattern of the fabric forms the decoration pattern 35.

Meanwhile, the finish member 30 is made of a thin flexible material. For example, the finish member 30 is formed by compression-molding any one of natural pulp or paper, interior sheets, thin film sheets of paper, pattern paper, PVC (polyvinylchloride) sheets, PP (polypropylene) sheets, and traditional window paper under a high temperature and high pressure. Accordingly, various patterns of the intermediate member 20 are well protruded onto the finish member 30. That is, various materials can be applied to the intermediate member 20 so that the decoration pattern 35 can be three-dimensionally formed thereon.

In addition, instead of the finish member 30 formed on the outer surface of the intermediate member 20, the upper surface of the intermediate member 20 can be painted with various paints so as to be finished.

Further, the finish member 30 is formed of an aluminum sheet for a flameproof or fire-resistant function. Otherwise, an aluminum sheet for a flameproof or fire-resistant function may be additionally formed on the surface of the finish member 30.

Reference numerals 100 and 100′ denote upper and lower compression rollers made of an elastic material such as rubber in which a heater 110 is housed, in order to compression-mold a decoration panel under a high temperature and high pressure, respectively. Reference numeral 200 denotes a hot press for compression-molding a decoration panel under a high temperature and high pressure.

Hereinbelow, a process of manufacturing a wallpaper type decoration panel having a decoration pattern of an unevenness form according to the present invention will be described with reference to the accompanying drawings.

As shown in FIG. 2, an intermediate member 20 which forms various decoration patterns 22 of a protruded form is adhered to the upper surface of a board member 10 such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate.

Here, a urethane binder, a hot melt, a water-resistant binder, or a cereal paste can be used as an adhesive for bonding the intermediate member 20.

Then, a finish member 30 is compression-molded on the outer surface of the intermediate member 20 under a high temperature and high pressure.

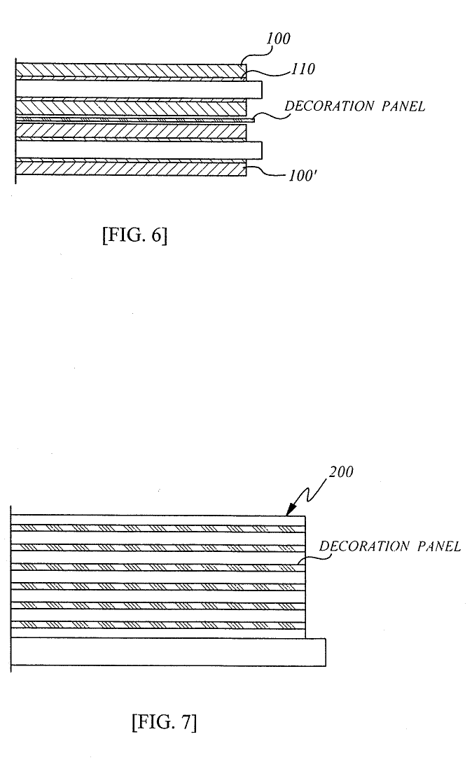

Here, as shown in FIG. 6, at the time of compression-molding, a decoration panel is passed through the upper and lower compression rollers 100 and 100′ in which the heater 110 is housed. Otherwise, a number of decoration panels are stacked one over another in a multiple stage, and then the stacked decoration panels are pressed by a hot press 200, to thereby achieve a compression-molding work under a high temperature and high-pressure.

If the decoration panel is compression-molded as described above, the finish member 30 is pressed on the outer surface of the intermediate member 20, so that the protruded pattern 22 of the intermediate member 20 is protruded as the decoration pattern 35 on the outer surface of the finish member 30.

Further, an embroidered fabric on which various patterns are protrudingly embroidered is used as the intermediate member 20, or a flocking processed fabric on which very small minute particles are sprayed to thus attach various patterns in a protruding form, is used as the intermediate member 20. Accordingly, the patterns 22 are easily expressed with the embroidered fabric or the flocking processed fabric, and thus the decoration patterns 35 are also easily expressed in various forms.

Unlike a conventional wallpaper construct ion method, the thus-fabricated wallpaper type decoration panel according to the present invention can be adhered on walls or ceilings, without needing an expert skill. That is, the wallpaper type decoration panel according to the present invention is cut into a predetermined size, to then be adhered on necessary places by an adhesion type, a modular type using a bracket, or a fixing tool such as TAKA™, conveniently.

The thus-fabricated decoration panels are attached on indoor or outdoor building materials, various kinds of furniture such as kitchen sink doors, various doors, lockers, ceilings, and covers for pillars, and other accessories in various forms, to thus improve aesthetics remarkably.

Further, the finish member 30 is formed of an aluminum sheet for a flameproof or fire-resistant function, and is used for the indoor or outdoor decoration members, and doors, to thereby provide a flameproof or fire-resistant effect as well as an interior effect.

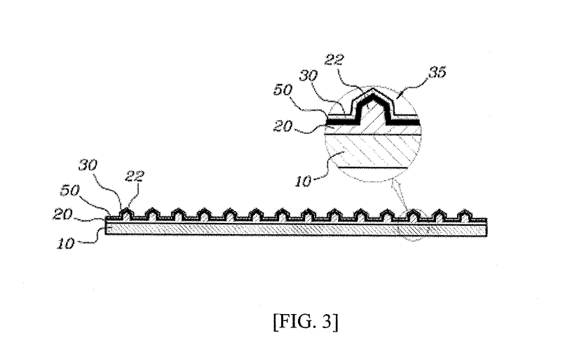

Meanwhile, as shown in FIG. 3, a wallpaper type decoration panel according to another embodiment of the present invention further includes a painted layer 50 which is painted between the intermediate member 20 and the finish member 30 using one of charcoal, lacquer, and yellow soil.

As described above, consumers various aesthetic desires are fulfilled by the various decoration patterns 35 which are protruded onto the surface of the board member. Far infrared rays which are healthful for human bodies are emitted from the painted layer 50 which is painted between the intermediate member 20 and the finish member 30 using one of charcoal, lacquer, and yellow soil. In addition, the painted layer 50 which is painted between the intermediate member 20 and the finish member 30 using one of charcoal, lacquer, and yellow soil may control humidity to thus provide a further healthful advantage.

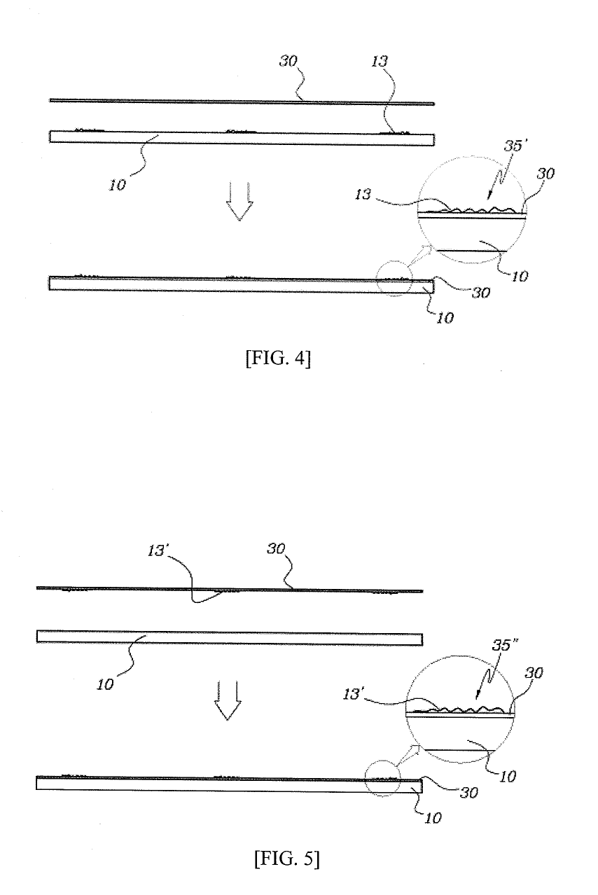

In addition, a wallpaper type decoration panel according to the present invention can be embodied in other forms as illustrated in FIGS. 4 and 5.

In the FIG. 4 embodiment, very small minute particles are sprayed on the upper surface of a board member 10 such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate, to thereby form a flocking pattern portion 13 and to thus attach various patterns in a protruding form. Then, a finish member 30 is compression-molded on the outer surface of the upper portion of the flocking pattern portion 13, under a high temperature and high pressure, so that a variety of the protruded patterns are formed by the flocking pattern portion 13 as the decoration pattern 35′ on the outer surface of the finish member 30.

In this embodiment, instead of adhering the intermediate member 20 on the upper surface of the board member 10, the flocking pattern portion 13 which has been directly flocking processed is formed, and then the finish member 30 is compression-molded under a high temperature and high pressure. Accordingly, the finish member is protruded by the flocking pattern portion 13 which has been adhered on the upper surface of the board member 10, to thus form the decoration patterns 35′ in various forms.

That is, instead of adhering the flocking processed fabric on the upper portion of the board member 10, the board member is directly flocking processed, to thus further simplify the manufacturing process.

Meanwhile, in the FIG. 5 embodiment, a finish member 30 which forms a flocking pattern portion 13′ is compression-molded on the upper surface of the board member 10 under a high temperature and high pressure, in which very small minute particles are sprayed on the upper surface of a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate, to thus attach various patterns in a protruding form. Accordingly, a variety of the protruded patterns are formed by the flocking pattern portion 13 as the decoration pattern 35″ on the outer surface of the finish member 30.

In comparison with the FIG. 4 embodiment, the flocking-processed flocking pattern portion 13′ is formed into the inner side surface of the finish member 30 other than the upper surface of the board member 10, and then the flocking pattern portion 13′ is compression-molded on the upper surface of the board member 10 under a high temperature and high pressure. Accordingly, the finish member 30 forms the decoration pattern 35″ in various forms in which the flocking pattern portion 13′ which has been adhered on the upper portion of the board member 10 is protruded.

Meanwhile, as described above, other than the fabric, all materials which form various patterns on the outer surface and various protruded patterns from the outer surface may be used as the intermediate member 20 which is adhered on the upper portion of the board member 10.

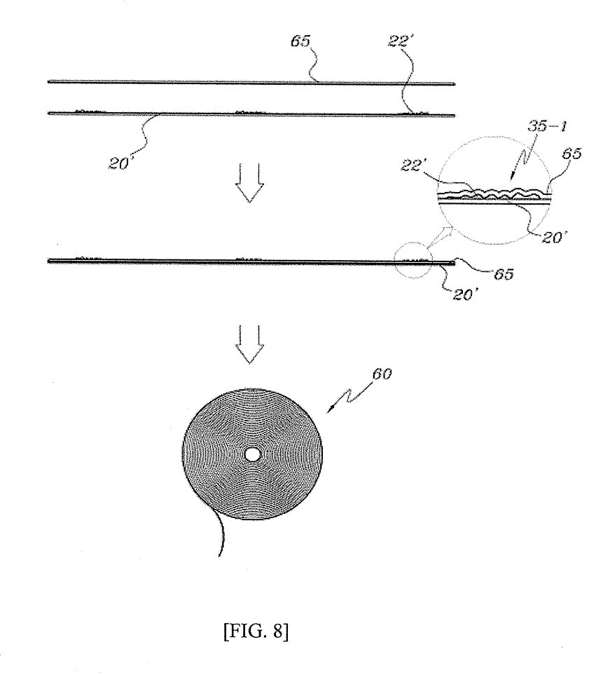

Meanwhile, a wallpaper type decoration panel having a decoration pattern of an unevenness form according to the present invention can be embodied as shown in FIG. 8. In the case of the wallpaper type decoration panel, an intermediate member 20′ which forms various decoration patterns 22′ of a protruded form which is directly overlaid on the surface of a sheet material 65 such as PVC (polyvinylchloride), paper, PP (polypropylene), to thereby form the decoration pattern 35-1. A sheet member 60 is adhered to the lower surface of the intermediate member 20′, and is wound in a roll form.

That is, in this embodiment, the sheet member 60 of a roll form and having the decoration pattern 35-1 on its surface is provided, to thereby provide an interior aesthetic sense of beauty, and simultaneously provide simplification and conveniences of carriage and installation of the wallpaper type decoration panel.

The sheet member 60 is cut into a predetermined size, to then be adhered on necessary places by an adhesive.

As described above, the wallpaper type decoration panel according to the present invention is formed by compressing and molding an intermediate member and a finish member on a board member under a high temperature and high pressure, in which the intermediate member and the finish member form various decoration patterns of an unevenness form on the upper surface of the board member. Accordingly, the pattern of the intermediate member is protruded as the decoration pattern on the outer surface of the finish member. Unlike a conventional mechanical method which forms a decoration pattern on aboard member as a limited form, a variety of decoration patterns can be formed on a board member, to thus fulfill various kinds of consumer's aesthetic desires and to maximize reliability of use. In order to form the decoration pattern, an embroidered fabric or a flocking processed fabric is used as the intermediate member. Otherwise, a flocking is directly attached on the upper surface of the board member or the inner side surface of the finish member. Accordingly, various decoration patterns are effectively produced, to thereby improve productivity and provide an effect of reducing a manufacturing cost.

In addition, the wallpaper type decoration panels according to the present invention are attached on indoor or outdoor building materials, various kinds of furniture such as kitchen sink doors, various doors, lockers, ceilings, and covers for pillars, and other accessories in various forms, to thus provide an effect of improving aesthetics remarkably.

The present invention is not limited to the above-described embodiments. It is apparent to one who has an ordinary skill in the art that there may be many modifications and variations within the same technical spirit of the invention.

What is claimed is:

1. A wallpaper type decoration panel having a decoration pattern of an unevenness form, the wallpaper type decoration panel comprising:
a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate;
an intermediate member which forms various decoration patterns of a protruded form and which is adhered to the upper surface of the board member; and
a finish member which is compression-molded on the outer surface of the intermediate member under a high temperature and high pressure, so that the protruded pattern of the intermediate member is protruded as the decoration pattern on the outer surface of the finish member,
the wallpaper type decoration panel further comprising:
a painted layer which is painted between the intermediate member and the finish member using one of charcoal, lacquer, and yellow soil.

2. The wallpaper type decoration panel according to claim 1, wherein an embroidered fabric on which various patterns are protrudingly embroidered is used as the intermediate member, so that the embroidered pattern of the fabric forms the decoration pattern, or a flocking processed fabric on which very small minute particles are sprayed to thus attach various patterns in a protruding form, is used as the intermediate member, so that the flocking pattern of the fabric forms the decoration pattern.

3. A wallpaper type decoration panel having a decoration pattern of an unevenness form, the wallpaper type decoration panel comprising:
a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate;
an intermediate member which forms various decoration patterns of a protruded form and which is adhered to the upper surface of the board member; and
a finish member which is compression-molded on the outer surface of the intermediate member under a high temperature and high pressure, so that the protruded pattern of the intermediate member is protruded as the decoration pattern on the outer surface of the finish member,
wherein an embroidered fabric on which various patterns are protrudingly embroidered is used as the intermediate member, so that the embroidered pattern of the fabric forms the decoration pattern.

4. A wallpaper type decoration panel having a decoration pattern of an unevenness form, the wallpaper type decoration panel comprising:
a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate;
an intermediate member which forms various decoration patterns of a protruded form and which is adhered to the upper surface of the board member; and
a finish member which is compression-molded on the outer surface of the intermediate member under a high temperature and high pressure, so that the protruded pattern of the intermediate member is protruded as the decoration pattern on the outer surface of the finish member,
wherein a flocking processed fabric on which very small minute particles are sprayed to thus attach various patterns in a protruding form, is used as the intermediate member, so that the flocking pattern of the fabric forms the decoration pattern.

5. The wallpaper type decoration panel according to any one of claims 1 to 4, wherein the finish member is formed by compression-molding any one of natural pulp or paper, interior sheets, thin film sheets of paper, pattern paper, PVC (polyvinylchloride) sheets, PP (polypropylene) sheets, and traditional window paper under a high temperature and high pressure.

6. The wallpaper type decoration panel according to any one of claims 1 to 4, wherein the finish member is formed of an aluminum sheet for a flameproof or fire-resistant function.

7. A wallpaper type decoration panel having a decoration pattern of an unevenness form, the wallpaper type decoration panel comprising:
a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate;
a flocking pattern portion in which very small minute particles are sprayed on the upper surface of the board member, to thus attach various patterns in a protruding form; and
a finish member which is compression-molded on the outer surface of the upper portion of the flocking pattern portion, under a high temperature and high pressure, so that a variety of the protruded patterns are formed by the flocking pattern portion as the decoration pattern on the outer surface of the finish member.

8. A wallpaper type decoration panel having a decoration pattern of an unevenness form, the wallpaper type decoration panel comprising:
a board member such as a medium-density fiberboard (MDF), a high-density fiberboard (HDF), a laminated veneer lumber (LVL), a laminated veneer board (LVB), a polypropylene board, a core board, a plywood, a steel iron plate, and an aluminum plate;
a finish member which forms a flocking pattern portion in which very small minute particles are sprayed on the upper surface of the board member, to thus attach various patterns in a protruding form, and which is compression-molded on the upper surface of the board member under a high temperature and high pressure, so that a variety of the protruded patterns are formed by the flocking pattern portion as the decoration pattern on the outer surface of the finish member.

9. A wallpaper type decoration panel having a decoration pattern of an unevenness form, the wallpaper type decoration panel comprising:
an intermediate member which forms various decoration patterns of a protruded form which is directly overlaid on the surface of a sheet material such as PVC (polyvinylchloride), paper, PP (polypropylene), to thereby form the decoration pattern; and
a sheet member which is adhered to the lower surface of the intermediate member, and wound in a roll form.
